(19) United States
(12) Patent Application Publication
(10) Pub. No.: US 2008/0212834 A1
(43) Pub. Date: Sep. 4, 2008

(54) User interface using camera and method thereof

(76) Inventor: Sung-Jin Oh, Cheongju-city (KR)

Correspondence Address: FLYNN THIEL BOUTELL & TANIS, P.C., 2026 RAMBLING ROAD, KALAMAZOO, MI, 49008-1631, US

(21) Appl. No.: 11/978,143

(22) Filed: Oct. 26, 2007

(30) Foreign Application Priority Data
Oct. 27, 2006 (KR) 10-2006-0104969

(51) Int. Cl. G06K 9/00

(52) U.S. Cl. 382/103

(57) ABSTRACT

A user interface using a camera and a method thereof, wherein two or more images that were shot in time sequence are preprocessed to form N×M matrices, and then each element of the matrices are compared. The comparison is thus made (N+1)(M+1) times to select a result of the highest similarity and produce a motion vector. The interface and method help to produce more accurate motion vectors and to obviate inaccuracy that is yielded throughout low-pass filtering.

This application claims the benefit of Republic of Korean Application No. 10-2006-0104969, filed Oct. 27, 2006, which is incorporated herein by reference.

### BACKGROUND OF THE INVENTION

1. Field of the Invention

The present invention relates generally to a user interface of mobile devices such as PDA, cellular phone, UMPC equipped with camera to activating functions of the devices by analyzing two of more pictures that are taken in time sequence.

2. Brief Description of The State of Knowledge in the Art

So far, research on the user interface by using camera has been pursued in two directions; either tracking subjects that are moving from a still camera's viewpoint or measuring movements of subjects when cameras are on the move.

Meanwhile, as usage of cell phones that are equipped with camera modules has been on the rise, development of interface has been underway to tap the devices. As continuous shooting capability of cell phones improved and click speed of central processing units of the phones increased, an interface based on such camera module has become viable. Therefore, it has been an urgent task to develop such interface.

Korean Patent Application No. 2005-112484 will make a good example of prior art. The method disclosed in the Korean application is performed as following; 1) eliminates noise in photographs by performing low-pass filtering and thus removing signals in unnecessary frequency areas, and 2) performs down-sampling, which is extracting pixels at certain interval points of the length and width of the photographs, and then 3) preprocesses the down-sampled pixels though methods such as P-tiling, average-binary coding, repeating binary-coding, or converting into grayscale of 8 bits or 1 bit black-and-white.

Then, the preprocessed photographs undergo the following; 1) pixel blocks are extracted that are comprised of certain colors (ideally color with the highest brightness), and 2) save coordinates of the pixel blocks as candidate areas when the number of pixels in the blocks is above the critical point, and the same process is applied to next images shot by a camera. If a change larger than permissible error range is observed when comparing coordinates of candidate areas in the two frames (images), a direction in which the camera should move is determined by using tracking function.

However, the Korean application failed to demonstrate reliable functions because of the following reasons.

1) when signals of unnecessary frequency areas were removed through lowpass filtering at the first and second stage of preprocessing, pixels were extracted simply based on intervals. Therefore, reliability of the preprocessing decreased significantly when the extracted pixels belonged to unremoved noise, or had starkly different colors from adjacent pixels that were largest in number.

2) The amount of information each pixel possesses substantially decreased during binary coding, which led to decreased volume of computation after preprocessing. In addition, the accuracy of operation fell when candidate area moved out of boundaries of image during comparing two frames (images), which resulted in selecting a wrong candidate area.

The invention aims to solve the above-mentioned problems and provide user interface by using highly reliable cameras that do not require exception handling.

### OBJECTS AND SUMMARY OF THE PRESENT INVENTION

Accordingly, a primary object of the present invention is to provide a method comprising the steps of: forming a first N×M matrix by preprocessing the first picture taken by camera; forming a second N×M matrix by preprocessing the second picture taken after the first picture; conducting comparison for each element of the first N×M matrix and the second N×M matrix for (N+1) (M+1) times; selecting most similar element from the results of the comparison; calculating a motion vector by shifting direction and range of the most similar element between the first N×M matrix and the second N×M matrix; and taking an action in accordance with the motion vector.

Yet another object of the invention is to provide a user interface comprising: A camera to shoot still or motion pictures; A preprocessing module to divide two pictures taken in time sequence by the camera into N×M pixel blocks, and to derive a N×M matrix that has average color value of each pixel blocks as elements; A tracking module to select the most similar element by comparing each elements of the two N×M matrices for (N+1) (M+1) times, and to calculate motion vector using the most similar element; and An interface module to take actions in accordance with the motion vector calculated by the tracking module.

### BRIEF DESCRIPTION OF THE DRAWINGS

FIG. 1 is a functional block drawing of the invention.

FIG. 2 is a flow chart of the invention, which illustrates a method to provide an interface by using camera.

FIG. 3 is a reference that exemplify a sample comparison in case N=M=2.

### DETAILED DESCRIPTION OF THE ILLUSTRATIVE EMBODIMENTS OF THE PRESENT INVENTION

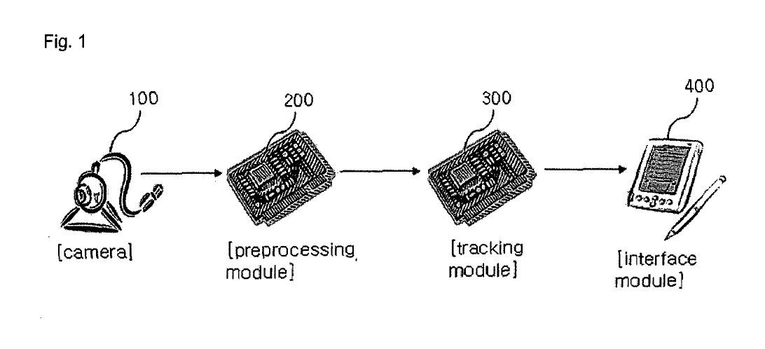

The following is detailed explanation of the user interface by using camera based on the attached drawing. FIG. 1 is a functional block drawing of the invention—an interface device that uses camera.

The invention is equipped with camera (100), preprocessing module (200), tracking module (300), and interface module (400). The invention can be applied to any device that has both camera and user interface, such as a mobile phone, PDA, digital camera, laptop and so on.

The above-mentioned camera (100) is to shoot a still or motion picture, and is a means to transfer images to the preprocessing module (200) to find out in what direction the camera moved by using tracking module (300). If it is more appropriate to take a motion picture, each frame should be transferred to preprocessing module (200) to enable real-time handling of each frame in the motion picture at both preprocessing module (200) and tracking module (300). Even for a still picture, a camera's direction has to be analyzed at the preprocessing (200) and tracking (300) modules, so several pictures are sent to preprocessing module (200) in time sequence. A test was conducted and revealed that smooth operation of a camera that could shoot more than 15 frames per second was made possible through an interface module (400). The same was observed in the case of still pictures taken by the same camera through the interface module (400). (hereafter “picture” means single frame of a motion picture or still picture.)

The ideal speed of picture transfer from camera (100) to preprocessing module (200) is more than 15 pictures per second. Each picture undergoes the following preprocessing and is sent to tracking module (300).

First, the received pictures are divided into N(length)×M(width) pixel blocks. (N, M are natural numbers)

If a picture taken by the camera (100) has the resolution of 640×480 and is divided into 5×5 pixel blocks, each pixel block has 12,288 pixels (128×96). Then average color value are derived from the 12,288 pixels. For instance, if each pixel has 24 bit color information and each piece of information is in RGB format, each R, G, and B has 256 phases of information. The average color value is calculated based on such color value.

Then, a N×M matrix is formed with the above-mentioned average color value as its elements. In the above case, two dimensional 5×5 matrix was used.

The derived average color value in the above example is 24 bit. Given that there is a margin of error between the color information of the picture and its adjacent colors, it needs to be quantumized so that it is converted into a natural number smaller than D. A test result showed that when D=2×M, the most accurate control was possible. In the test, color information that was comprised of (8 bit, 8 bit, 8 bit) was quantumized. (in the above example where N=M=5, D was set as 10)

As it was shown above, each element of N×M matrix is quantumized, completing preprocessing. The preprocessing module (200) performs preprocessing a picture sent by the camera (100) as mentioned above, produces a N×M matrix and sends it to tracking module (300).

A tracking module (300) receives the N×M matrix (hereafter “the first N×M matrix”) produced by the preprocessing module (200), which processed multiple pictures that were shot in time sequence. The tracking module first produces a motion vector by using the N×M matrix it first received and another N×M matrix (hereafter “the second N×M matrix”) it receives later.

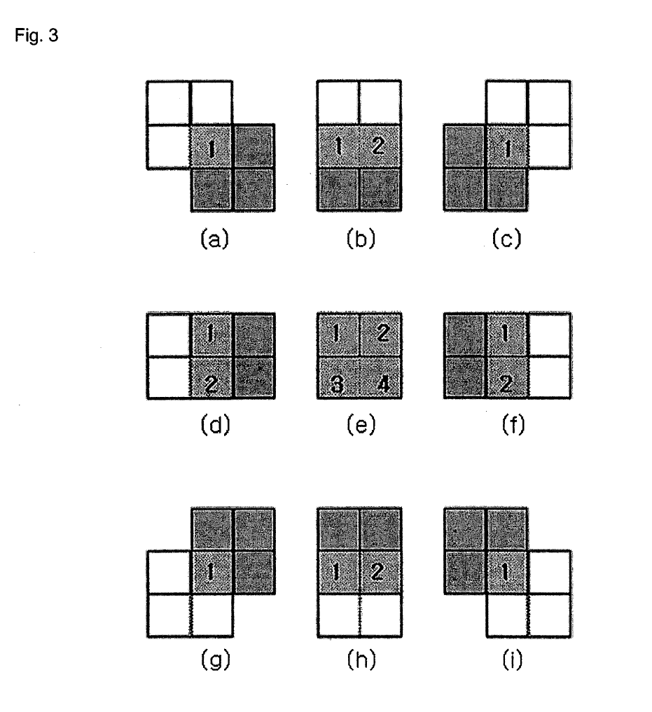

FIG. 3 exemplifies sample-comparison when N=M=2. FIG. 3 suggests that when N=M=2, (N+1) (M+1)=9, which means samples are compared for 9 times. In the FIG. 3, a white square represents the second N×M matrix, while a gray square represents the first N×M matrix.

In (b) of FIG. 3, the white square is located on the upper part of the gray square, which means that elements of the second N×M matrix are similar in number with elements of the first N×M matrix. In other words, camera moved upward. In (d) of FIG. 3, it can be concluded that camera moved to the left. In (h) of FIG. 3, camera moved downward.

FIG. 3 exemplifies when N=M=2. If N or M increases, elements of the second N×M matrix are compared to elements of the first N×M matrix (hereafter “sample comparison”) to learn not only movement direction but also distances camera traveled (or speed).

If more than one similar pattern is observed in element numbers of the second or first N×M matrix during sample comparison, it becomes impossible to know the exact direction of movement. In order to learn the direction, the highest similarity is chosen by applying formula 1 to performing sample comparison for (N+1) (M+1) times.

$$SIMILARITY ( \% ) = \frac{Number of Similar Points ( Pixels )}{Number of Points ( Pixels ) in Compared Element} \qquad [ Formula 1 ]$$

In other words, when comparing N×M elements of two matrices, the highest rate of similarity is chosen by counting the number of similar points (pixels) among compared element.

In such case, a vector (hereafter “motion vector”) is formed, which suggests (1) in what direction the second N×M matrix moved and (2) how far it moved away from the first N×M matrix.

The higher N and M increase, the smoother the movement is. However, if N and M increase too higher, the number of sample comparison becomes (N+1)̂2 (N=/M), increasing time complexity to O(N2).

Such algorithm with time complexity is only applicable when N is relatively smaller. Such algorithm is also inappropriate as interface, since bigger N makes it respond to subtle vibration of camera (100). (Except supervising conveyor belt or surveillance camera, when subtle movements need to be seen. In these cases, N could be set higher.) Test results showed that functions were most stable when N(=/M) was in the range from 8 to 32.

The tracking module sends the motion vector to interface module (400). The interface module performs functions or capabilities in accordance with the motion vector it received. For example, movement of a mouse can be emulated based on the motion vector. In addition, certain functions can be enabled or disabled based on the direction or size of the motion vector. Such interface module (400) is defined as module, but its capabilities are not limited to use interface of the GUI environment. As long as it reacts to motion vectors, certain shapes or forms do not limit the interface.

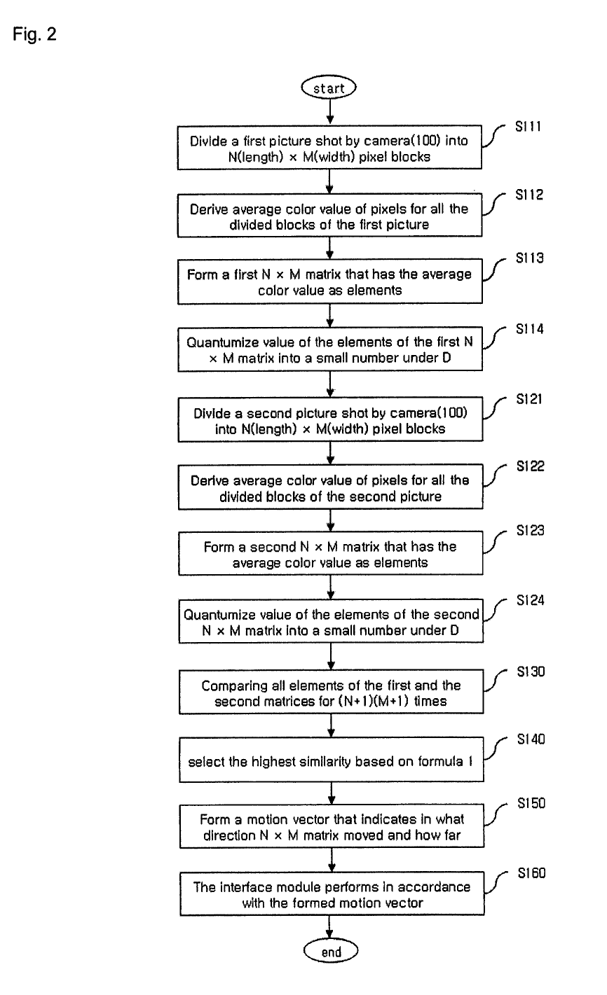

From now on, I will explain how the interface that uses camera is provided by citing FIG. 2. FIG. 2 is a flow chart, which shows how the interface is provided by using camera. Overlapping explanations will not be explained.

First, a picture shot by camera (100) is divided into N(length)×M(width) pixel blocks (S111). N and Mare natural numbers. If an interface module (400) has a display, and the display has the same length and width, it is appropriate to have N equal to M.

Average color value of pixels are derived (S112) for all the divided blocks and form a first N×M matrix that has the average color value as elements (S113). For instance, elements of the above-mentioned matrix can have (8 bit, 8 bit, 8 bit) format and can express 24 bit information of color. Considering the margin of error of color information, the numbers of elements are quantumized into natural numbers smaller than D (S114). In the above-mentioned example, each of 8 bit (=256) elements are quantumized into a small number under D.

The same process—from S111 to S114—is applied to a next picture taken by camera (100) (S121 to S124)

For each element of the two N×M matrix formed through the above-mentioned process, sample comparison is conducted for (N+1) (M+1) times (S130). Then, select the highest similarity based on formula 1 (S140).

Based on the selection, Form a motion vector that indicates 1) in what direction the second N×M matrix moved from the first one and 2) how far (S150).

The interface module performs in accordance with the formed motion vector (S160).

The user interface by using camera resolves the problem of inaccurate calculation of motion vectors, overcomes disadvantages during noise reduction by lowpass filtering, and offers the highest quality by setting D=N×2 and thus setting the most optimized quantum level.

Several modifications to the illustrative embodiments have been described above. It is understood, however, that various other modifications to the illustrative embodiment of the present invention will readily occur to persons with ordinary skill in the art. All such modifications and variations are deemed to be within the scope and spirit of the present invention as defined by the accompanying Claims to Invention.

What is claimed is:

1. A Method to provide user interface using camera, comprising the steps of:
(110) forming a first N×M matrix by preprocessing the first picture taken by camera;
(120) forming a second N×M matrix by preprocessing the second picture taken after the first picture;
(130) conducting comparison for each element of the first N×M matrix and the second N×M matrix for (N+1) (M+1) times;
(140) selecting most similar element from the results of the comparison conducted at step (130);
(150) calculating a motion vector by shifting direction and range of the most similar element between the first N×M matrix and the second N×M matrix; and
(160) taking an action in accordance with the motion vector.

2. The method of claim 1, wherein step (110) further comprising the steps of:
(111) dividing the first picture taken by camera into N(length)×M(width) pixel blocks;
(112) calculating average color value of each of the N×M blocks;
(113) forming the first N×M matrix that have the average color value of the N×M blocks as elements;
(114) quantumizing each element of the first N×M matrix in order for the element to be under the predetermined natural number D.

3. The method of claim 2, wherein the predetermined natural number D equals to twice of N.

4. The method of claim 1, wherein step (120) further comprising the steps of:
(121) dividing the second picture taken after the first picture by camera into N(length)×M(width) pixel blocks;
(122) calculating average color value of each of the N×M blocks;
(123) forming the second N×M matrix that have the average color value of the N×M blocks as elements;
(124) quantumizing each element of the second N×M matrix in order for the element to be under the predetermined natural number D.

5. The method of claim 4, wherein the predetermined natural number D equals to twice of N.

6. A user interface using camera, comprising:
A camera to shoot still or motion pictures;
A preprocessing module to divide two pictures taken in time sequence by the camera into N×M pixel blocks, and to derive a N×M matrix that has average color value of each pixel blocks as elements;
A tracking module to select the most similar element by comparing each elements of the two N×M matrices for (N+1) (M+1) times, and to calculate motion vector using the most similar element;
An interface module to take actions in accordance with the motion vector calculated by the tracking module.
